(19) United States
(12) Patent Application Publication
(10) Pub. No.: US 2024/0375162 A1
(43) Pub. Date: Nov. 14, 2024

(54) Method of Soil Contaminant Remediation Using Cannabis and/or Hemp Plants

(71) Applicant: CloneSmart, LLC, Orangevale, CA (US)

(72) Inventor: Ryan George, Carmichael, CA (US)

(21) Appl. No.: 18/313,887

(22) Filed: May 8, 2023

(51) Int. Cl. B09C 1/10

(52) U.S. Cl. CPC B09C 1/105; B09C 2101/00

(57) ABSTRACT

A method of using cannabis and/or hemp plants to remove soil contaminants, such as heavy metals and organic compounds, through phytoremediation. The method involves cultivating cannabis and/or hemp plants in soil contaminated with targeted pollutants, allowing the plants to uptake the contaminants, and then harvesting and disposing of the contaminated plants. The method is cost-effective, environmentally friendly, and can be used to remediate contaminated soil in a variety of settings, including industrial sites and agricultural lands.

### BACKGROUND

Soil contamination has become a significant environmental issue, especially in industrial areas and agricultural lands. Traditional remediation methods, such as excavation and soil removal, can be costly, time-consuming, and may cause disruption to the surrounding environment.

Phytoremediation, the use of plants to remove pollutants from the soil, has emerged as an attractive alternative due to its cost-effectiveness and environmental friendliness.

Cannabis and hemp plants have shown promise in phytoremediation due to their ability to accumulate high levels of contaminants and their fast growth rate.

In addition to industrial and agricultural sites, soil contamination can also be a concern for properties undergoing development. Prior to construction, an environmental site assessment (ESA) phase one and two is often conducted to identify and evaluate any potential environmental liabilities associated with the property. This assessment typically includes a review of historical records, site inspections, and soil sampling. The presence of contaminants in the soil can lead to delays and additional costs associated with remediation prior to construction.

### BRIEF SUMMARY

The present invention provides a method of using cannabis and/or hemp plants to remove a variety of soil contaminants through phytoremediation. The method can be used to remediate soil contaminated with volatile organic compounds (VOCs), methane, carbon monoxide, radon, petroleum hydrocarbons, heavy metals, polychlorinated biphenyls (PCBs), pesticides, and asbestos. Prior to construction, an environmental site assessment phase I can identify any potential soil contamination issues, including these specific contaminants. Prior to an agricultural application, a soil analysis can identify any potential soil contamination issues, including these specific contaminants. In either case, if contaminants are found, the method can be employed to remediate the soil prior to construction.

Cannabis and hemp plants have a high contaminant uptake and accumulation abilities, the method can effectively remove targeted contaminants from the soil. For example, cannabis or hemp plants can remove VOCs through a process called phytovolatilization, where the plants absorb the VOCs and release them into the air through transpiration. Methane can be removed through a process called phytoextraction, where the plants absorb the methane through their roots and convert it to carbon dioxide. Carbon monoxide can be removed through a combination of phytovolatilization and phytoextraction. Radon can be removed through a process called phytostabilization, where the plants absorb the radon and stabilize it in the soil. Petroleum hydrocarbons, heavy metals, PCBs, and asbestos can be removed through a combination of phytodegradation, where the plants break down the contaminants, and phytoextraction, where the plants absorb the contaminants through their roots.

The remediation process can be monitored through soil sampling and laboratory analysis. This method offers a promising approach to address the growing issue of soil contamination and can contribute to the development of sustainable and eco-friendly environmental remediation practices.

### DETAILED DESCRIPTION

In one embodiment of the invention, cannabis and/or hemp plants are selected based on their ability to uptake and accumulate targeted soil contaminants. The selection can be based on the plant's genetic makeup, such as its metal uptake genes or its ability to metabolize organic compounds. The selection can also be based on the plant's growth characteristics, such as its biomass production and its root structure.

In another embodiment of the invention, the selected plants are cultivated in soil contaminated with the targeted contaminants. The soil can be treated with organic or inorganic amendments to improve plant growth and remediation efficiency. The cultivation can be done in a greenhouse or in an open field, depending on the location and the climate.

In another embodiment of the invention, the process can be used as part of a Phase II site assessment for remediation prior to construction. After completing a Phase I environmental site assessment, if soil contamination is found, a Phase II assessment is conducted to determine the extent and severity of contamination. In this embodiment, the contaminated soil is remediated using the process described above, allowing for safe construction of buildings or other structures.

In another embodiment of the invention, the process can be used to remediate soil on agricultural land prior to planting a new crop. This method can be particularly useful for organic farmers who are looking for natural methods of soil remediation. The contaminated soil is treated using the process described above, allowing for a safe and healthy growing environment for the next crop.

In another embodiment of the invention, the harvested plants are processed to extract fibers for textiles and paper. The fibers can be used in the manufacturing of clothing and other textile products, as well as paper products. This method provides a sustainable and environmentally friendly alternative to traditional fiber extraction methods.

In another embodiment of the invention, the harvested plants are processed to extract essential cannabinoids and oils, as well as other plant compounds. These compounds have a range of medicinal and therapeutic properties and can be used in a variety of applications, including pharmaceuticals, personal care products, and food and beverage products.

In another embodiment of the invention, the harvested plants can be processed into bio diesel, providing a sustainable and renewable alternative to traditional fossil fuels. This method can help reduce dependence on non-renewable resources and reduce carbon emissions.

In another embodiment of the invention, the plants are allowed to grow and uptake the targeted contaminants through their roots and above-ground plant parts. The growth period can vary depending on the type and concentration of the contaminants and the plant species used. The plants can be monitored for growth rate, biomass production, and contaminant uptake.

In another embodiment of the invention, the plants are harvested once they have accumulated the targeted contaminants to a desired level. The harvesting can be done manually or mechanically, depending on the size and density of the plants. The harvested plants are removed from the contaminated soil to prevent re-contamination.

In another embodiment of the invention, the harvested plants are disposed of in a manner that minimizes environmental impact. The disposal can be done through incineration or by disposing of the plants in a hazardous waste landfill. The disposal method is chosen based on the concentration and type of contaminants in the plants.

In another embodiment of the invention, the remediated soil is monitored to ensure that the targeted contaminants have been removed to an acceptable level. The monitoring can be done through soil sampling and laboratory analysis. The soil can be reused for agricultural or industrial purposes once the contaminants have been removed to an acceptable level.

### CONCLUSION

In conclusion, the use of cannabis or hemp plants for phytoremediation offers a promising approach to address the issue of soil contamination. By selecting plants with high contaminant uptake and accumulation abilities, targeted contaminants such as VOCs, methane, carbon monoxide, radon, petroleum hydrocarbons, heavy metals, PCBs, pesticides, and asbestos can be effectively removed from the soil prior to construction. The method can be integrated into the environmental site assessment process to identify and address potential environmental liabilities associated with soil contamination, leading to a more efficient and cost-effective development process.

By incorporating sustainable and eco-friendly environmental practices such as phytoremediation, we can promote a healthier environment for ourselves and future generations. The remediation process not only removes harmful contaminants but also promotes the growth of beneficial plants that can improve soil quality and increase biodiversity. The integration of this method into the environmental site assessment process can help to ensure that soil contamination issues are addressed proactively, rather than reactively, resulting in a more sustainable and resilient built environment.

Overall, the use of cannabis or hemp plants for phytoremediation represents an innovative and practical solution to the challenges of soil contamination. This technology has the potential to transform the way we approach environmental site assessments and construction practices, promoting a more sustainable and responsible approach to development.

I claim:

1. A method of phytoremediation of soil contaminants using cannabis and/or hemp plants, comprising cultivating the selected plants in soil contaminated with targeted pollutants, allowing the plants to uptake the contaminants, and then harvesting and disposing of the contaminated plants.

2. The method of claim 1, wherein the selected cannabis and/or hemp plants are chosen based on their ability to uptake and accumulate targeted soil contaminants.

3. The method of claim 1, wherein the cultivation is done in a greenhouse or in an open field, depending on the location and the climate.

4. The method of claim 1, wherein the contaminated soil is treated with organic or inorganic amendments to improve plant growth and remediation efficiency.

5. The method of claim 1, wherein the process is used as part of a Phase II site assessment for remediation prior to construction.

6. The method of claim 1, wherein the harvested plants are processed to extract fibers for textiles and paper.

7. The method of claim 1, wherein the harvested plants are processed to extract essential cannabinoids and oils, as well as other plant compounds.

8. The method of claim 1, wherein the harvested plants can be processed into bio diesel.

9. The method of claim 1, wherein the selected cannabis and/or hemp plants are chosen based on their genetic makeup, such as their metal uptake genes or their ability to metabolize organic compounds.

10. The method of claim 1, wherein the cultivation of the selected plants is done to remove volatile organic compounds (VOCs) through phytovolatilization, methane through phytoextraction and conversion to carbon dioxide, carbon monoxide through a combination of phytovolatilization and phytoextraction, radon through phytostabilization, and petroleum hydrocarbons, heavy metals, polychlorinated biphenyls (PCBs), and asbestos through a combination of phytodegradation and phytoextraction.

11. The method of claim 1, wherein the remediation process is monitored through soil sampling and laboratory analysis.

12. The method of claim 1, wherein the process is used to remediate soil on agricultural land prior to planting a new crop.

13. The method of claim 1, wherein the method provides a sustainable and eco-friendly environmental remediation practice.
